(19) United States
(12) Patent Application Publication
(10) Pub. No.: US 2003/0192598 A1
(43) Pub. Date: Oct. 16, 2003

(54) Apparatus for modulating fluid flow

(75) Inventors: Albert Chadwick Hobson, Attadale (AU); Peter Guy Hobson, Subiaco (AU)

Correspondence Address: MERCHANT & GOULD PC, P.O. BOX 2903, MINNEAPOLIS, MN, 55402-0903, US

(73) Assignee: CHADSON ENGINEERING PTY LTD., Balcatta (AU)

(21) Appl. No.: 10/418,528

(22) Filed: Apr. 17, 2003

Related U.S. Application Data
(63) Continuation of application No. 09/786,303, filed on May 25, 2001, now abandoned.
Application No. 09/786,303 is a 371 of international application No. PCT/AU99/00719, filed on Sep. 3, 1999.

(30) Foreign Application Priority Data
Sep. 3, 1998 (AU) PP 5684

(51) Int. Cl. E03B 7/07; E04H 4/12; E04H 4/14; F16L 25/00; F16L 27/08; F16L 27/087; F16L 27/093

(52) U.S. Cl. 137/561 A

(57) ABSTRACT

An apparatus (10) for modulating fluid flow which comprises a first flow path (13) and a second flow path. The second flow path is transverse to the first flow path (13), and has a fluid inlet (31) which opens onto the first flow path (13). The fluid inlet (31) is such that a portion of fluid flowing along the first flow path (13) is diverted into the second flow path. The position of the fluid inlet (31) is set in relation to the direction of fluid flow in the first flow path (13) and in relation to the extent of fluid to be diverted from the first flow path (13) into the second flow path.

### FIELD OF THE INVENTION

This invention relates to apparatus for modulating fluid flow. More particularly, the invention relates to apparatus for modulating fluid flow between a first fluid path and a second flow path which branches from the first flow path.

### DISCLOSURE OF THE INVENTION

The invention provides apparatus for modulating fluid flow comprises a first flow path, a second flow path transverse to the first flow path, the second flow path having a fluid inlet which opens onto the first flow path whereby a portion of fluid flowing along the first flow path can be diverted into the second flow path, the position of the fluid inlet being set in relation to the direction of fluid flow according to the extent of fluid to be diverted from the first flow path into the second flow path.

Typically, the position of the inlet is fixed with respect to the direction of fluid flow in the first flow path after having been placed in the set position. However, there may be situations where the position of the fluid inlet can be adjusted to vary the extent of fluid diverted as desired. Such adjustment may be made prior to and/or during operation of the apparatus.

The second flow path may be defined by a conduit which extends into the first flow path but which does not entirely block fluid flow therealong. The fluid inlet may be located in a side wall of the conduit. Where the conduit is of circular cross section, the fluid inlet would be located in the cylindrical side wall of the conduit.

The fluid inlet may comprise one or more apertures. In a particularly advantageous arrangement, the fluid inlet comprises two apertures circumferentially spaced about the conduit.

The conduit may extend entirely across the first fluid path thereby providing two branch lines extending from opposed sides of the first flow path.

There may be a plurality of said conduits positioned at spaced intervals along the first flow path.

The first flow path may be defined by a conduit having an internal size greater than the external size of the conduit defining the second flow path.

The invention has been devised particularly, although not solely, for use in a fluid distribution manifold having a plurality of branch outlets, the arrangement allowing fluid discharging from the manifold through the branch outlets to be regulated. The regulation may allow, for example, a uniform fluid flow through each of the branch outlets. Typically, a conventional manifold having a plurality of branch outlets does not provide an even distribution of fluid flowing through the various branch outlets.

A particular application of the apparatus according to the invention is in a horizontal swimming pool filter. A horizontal swimming pool filter typically has an inlet manifold positioned above a filtering media, the purpose of the manifold being to distribute water to be filtered evenly within a water space above the filtering media, so as to allow a laminar flow which does not disturb the surface of the filtering media bed. Uneven distribution of water would cause currents in the water space above the filtering media bed, causing scouring in the surface of the filtering media which in turn causes the filtering media to migrate, leaving areas of reduced media depth.

### BRIEF DESCRIPTION OF THE DRAWINGS

The invention will be better understood by reference to the following description of several specific embodiments thereof as shown in the accompanying drawings in which:

FIG. 1 is a schematic plan view of a water distribution manifold according to a first embodiment as used in a horizontal swimming pool filter;

FIG. 2 is a schematic end view of the manifold;

FIG. 3 is a view, partly cut-away, illustrating the position of various branch lines in the main chamber of the manifold;

FIG. 4 is a schematic end view of a water distribution manifold according to a second embodiment, showing apertures in one position; and

FIG. 5 is a view similar to FIG. 4 except that apertures are shown in another position.

### BEST MODE(S) FOR CARRYING OUT THE INVENTION

The embodiments shown in the drawings are each directed to a manifold for use in a horizontal swimming pool filter, the manifold being provided to distribute pool water evenly into a water space above a bed of filtering media contained within the filter.

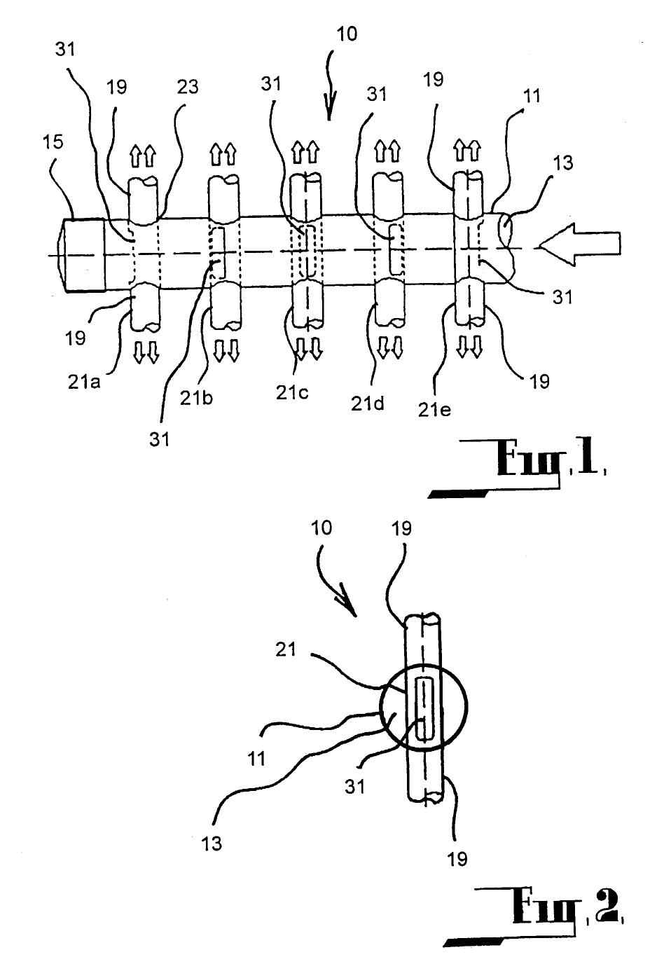

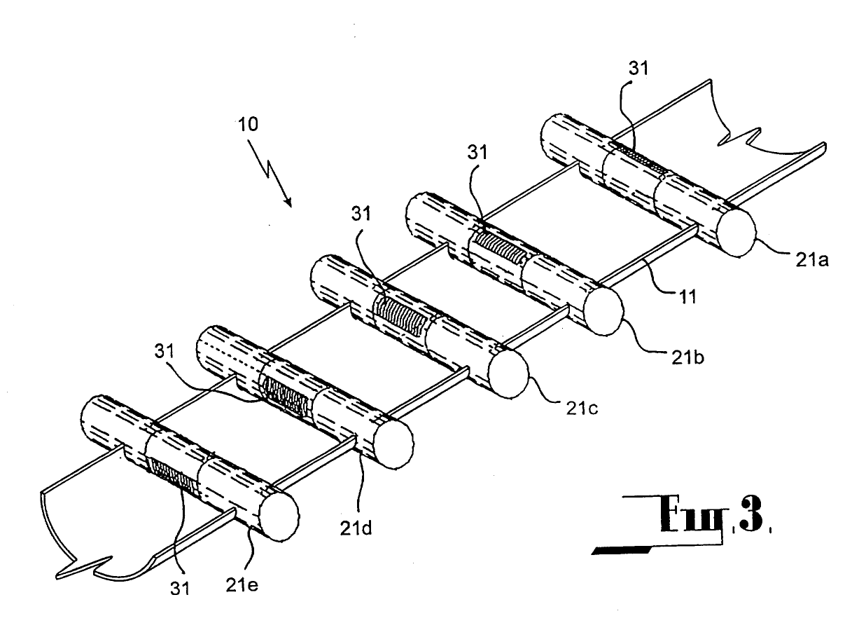

In the first embodiment shown in FIGS. 1, 2 and 3, the manifold 10 comprises a first conduit 11 defining a first flow passage 13. The conduit 11 is cylindrical and closed at one end by way of a cap 15. Pool water to be filtered is delivered to the flow passage 13 through the other end of the conduit 11.

The manifold 10 further includes a plurality of branch lines 19. The branch lines 19 are in pairs on opposed sides of the first conduit 11, each pair of branch lines 19 being defined by a second conduit 21 extending transversely through the first conduit 11. Each second conduit 21 is received within holes 23 formed in the cylindrical side wall of the first conduit 11. In the first embodiment shown in the drawings, there are five such second conduits 21, identified by reference numerals 21a, 21b, 21c, 21d and 21e respectively. Each second conduit 21 has an external diameter which is less than the interior diameter of the first conduit 11.

In this way, the second conduits do not block flow along the first flow passage 13. The second conduits 21 do, however, act as baffles in the first flow passage 13.

Each conduit 21 has a fluid inlet 31 opening into the interior of the first flow passage. With this arrangement, some of the fluid within the first flow passage can be diverted into the second conduit through the fluid inlet 31. The diverted fluid then flows along the two branch lines 19 defined by the respective second conduit 21.

The extent to which fluid is diverted from the first conduit 11 into each second conduit 21 can be regulated by the orientation of the inlet 31 with respect to the first conduit. In this way, the fluid inlets 31 in the five second conduits shown in the drawings can be so positioned that the volumetric flow rate of fluid through each of the branch lines 19 is approximately equal. As can be seen from FIG. 1 of the drawings, the fluid inlets 31 in the second conduits 21, have a range of positions including a position which directly faces the fluid flow in the first conduit, a position which faces a direction generally normal to the fluid flow and a position which faces a direction opposite to the fluid flow.

In assembling the manifold, the various second conduits 21 are rotated within the first conduit 11 so that the respective inlets 31 assume the required position and then the second conduits 21 are sealingly fixed in position within the first conduit 11. The fixing can be achieved in any suitable fashion such as by adhesive bonding or welding.

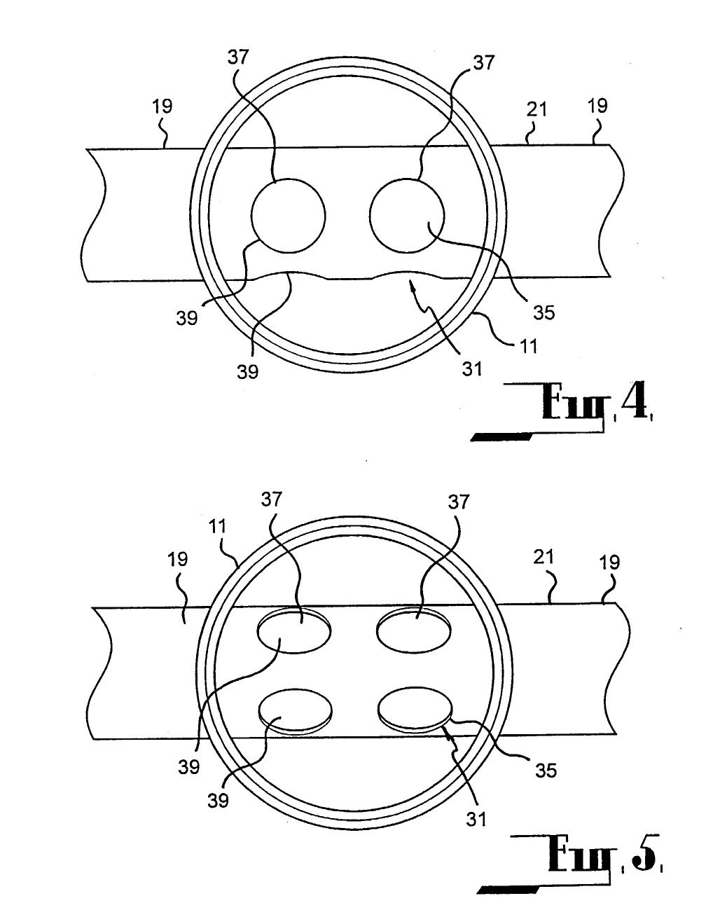

In the embodiment shown in FIGS. 1, 2 and 3 of the drawings, the fluid inlet 31 in each second conduit 21 is defined by a single aperture in the cylindrical side wall of the conduit. Referring now to FIGS. 4 and 5 of the drawings, there is shown apparatus according to a second embodiment in which each fluid inlet 31 comprises a plurality of apertures 35 in the cylindrical side wall of the respective second conduit 21. In the embodiment as shown, there are four such apertures 35, each of circular cross-section. The apertures 35 are in pairs 37, with the two apertures 39 in each pair being circumferentially spaced with respect to each other. The circumferential spacing is such that the centres of the apertures 39 in each pair 37 are approximately at 90° with respect to each other. In FIG. 4 of the drawings, the second conduit is shown in an orientation in which one aperture 39 of each pair is directly facing the direction of fluid flow and the other aperture 39 of each pair is facing a direction generally normal to the direction of fluid flow. In FIG. 5 of the drawings, the second conduit 21 is shown in an orientation in which the apertures 39 in each pair 37 obliquely face the direction of fluid flow.

It should be understood that the apparatus can be operated in a reverse flow mode in which fluid enters the manifold 10 through the branch lines 19 and exits through the first conduit 11. In such use, the fluid inlets 31 can produce a venturi effect in the manifold.

From the foregoing, it is evident that the present invention provides a simple yet highly effectively apparatus for modulating fluid flow.

While the apparatus has been described in each of the two embodiments in an arrangement which provides uniform flow through the various branch lines, it should be understood that it can be arranged to deliver prescribed but nevertheless uneven flows to the various branch lines.

It should also be understood that the apparatus according to the invention has application for fluid flows other than pool water. Indeed, the apparatus may have application for modulating flow of any liquid or gaseous fluid (or combination thereof.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims defining the invention are as follows

1. An apparatus for modulating fluid flow comprising a first flow path, a second flow path transverse to the first flow path, the second flow path having a fluid inlet which opens onto the first flow path whereby a portion of fluid flowing along the first flow path is diverted into the second flow path, the position of the fluid inlet being set in relation to the direction of fluid flow according to the extent of fluid to be diverted from the first flow path into the second flow path.

2. An apparatus for modulating fluid flow according to claim 1 wherein the position of the inlet is fixed with respect to the direction of fluid flow in the first flow path after having been placed in the set position.

3. An apparatus for modulating fluid flow according to claim 1 wherein the position of the fluid inlet is adjustable for varying the extent of fluid diverted.

4. An apparatus for modulating fluid flow according to claim 1, 2 or 3 wherein the second flow path is defined by a conduit which extends into the first flow path but which does not entirely block fluid flow therealong.

5. An apparatus for modulating fluid flow according to any one of the preceding claims wherein the fluid inlet is located in a side wall of the conduit.

6. An apparatus for modulating fluid flow according to claim 5 wherein the conduit is circular in cross section, said fluid inlet is located in the cylindrical side wall of the conduit.

7. An apparatus for modulating fluid flow according any one of the preceding claims wherein the fluid inlet comprises one or more apertures.

8. An apparatus for modulating fluid flow according to claim 7 wherein the fluid inlet comprises two apertures circumferentially spaced about the conduit.

9. An apparatus for modulating fluid flow according to any one of claims 4 to 8 wherein the conduit extends across the first fluid path thereby providing two branch lines extending from opposed sides of the first flow path.

10. An apparatus for modulating fluid flow according to any one of claims 4 to 9 wherein a plurality of said conduits are positioned at spaced intervals along the first flow path.

11. An apparatus for modulating fluid flow according to any one of the preceding claims wherein the said first flow path is defined by a conduit having an internal size greater than the external size of the conduit defining the second flow path.

12. An apparatus for modulating fluid flow substantially as herein described with reference to the accompanying drawings.
